(19) United States
(12) Patent Application Publication
(10) Pub. No.: US 2019/0121450 A1
(43) Pub. Date: Apr. 25, 2019

(54) INTERACTIVE DISPLAY SYSTEM AND CONTROL METHOD OF INTERACTIVE DISPLAY

(71) Applicants: Industrial Technology Research Institute, Hsinchu (TW); Intellectual Property Innovation Corporation, Hsinchu (TW)

(72) Inventors: Chih-Chia Chang, Hsinchu County (TW); Sheng-Po Wang, Taoyuan City (TW); Yu-Hsin Lin, Miaoli County (TW)

(73) Assignees: Industrial Technology Research Institute, Hsinchu (TW); Intellectual Property Innovation Corporation, Hsinchu (TW)

(21) Appl. No.: 15/997,707

(22) Filed: Jun. 5, 2018

Related U.S. Application Data
(60) Provisional application No. 62/574,740, filed on Oct. 19, 2017.

(30) Foreign Application Priority Data
Dec. 20, 2017 (TW) 106144684

(51) Int. Cl. G06F 3/03; G06F 3/038

(52) U.S. Cl. CPC G06F 3/0317; G06F 2203/0384; G06F 3/038

(57) ABSTRACT

An interactive display system and an interactive display controlling method are provided. The interactive display system includes an interactive controller and an interactive display module. The interactive controller includes multiple marking patterns presented on a surface of the interactive controller. The interactive display module includes a display, an image capturing device and a processor. The image capturing device captures a marking image of the marking patterns. The processor is coupled to the display and the image capturing device, the processor obtains location information of the interactive controller, calculates a directional angle of the interactive controller according to a relative position relationship of the marking patterns in the marking image, and calculates a directional coordinate of the interactive controller according to the directional angle and the location information. The display displays an indication object at a position associated with the directional coordinate.

### CROSS-REFERENCE TO RELATED APPLICATION

This application claims the priority benefits of a U.S. provisional application Ser. No. 62/574,740, filed on Oct. 19, 2017 and a Taiwan application serial no. 106144684, filed on Dec. 20, 2017. The entirety of each of the above-mentioned patent applications is hereby incorporated by reference herein.

### BACKGROUND OF THE DISCLOSURE

### Field of the Disclosure

The disclosure relates to an interactive display system and a control method of interactive display.

### Description of Related Art

Units that operate view spots or exhibition locations usually produce information providing media such as message boards, voice guides, etc. for users to use, such that the users may have a better understanding of scene objects (for example, artworks, famous buildings, scene spots, marine lives, or exhibited antiques). Along with development of technology, multimedia providing media such as an electronic display board is gradually widely used. However, most of the aforementioned information providing media provide information to the users in a fixed and predetermined way, and is not liable to implement interaction with the users, and cannot immediately present related information of the scene objects that the users are interested in.

Although an interactive display method combining a display technique with a biometrical characteristics tracking technique or a touch control technique is gradually applied to various applications, these techniques respectively have their own limitations. For example, regarding an application environment using a human eye tracking technique to implement interactive display control, if a distance between the detected user and a human eye tracking module is too close or too far away, normal operation cannot be implemented due to that the user's line of sight cannot be correctly identified, and it is also unable to detect multiple users at the same time. Moreover, the touch control technique may work when the user touches or approaches to the touch panel, which is adapted to a near distance interactive display control. Moreover, a spatial limb identification technique that uses a video camera to capture images for identifying human body movements also requires a specific detection distance, and a spatial limb identification algorithm is relatively complicated and consumes more computing resources. In case that the interactive display technique is introduced to guide applications of scene objects, how to accurately detect movements of the user and the user's viewing attempts and correspondingly provide appropriate response actions still have more improvements.

### SUMMARY OF THE DISCLOSURE

An embodiment of the disclosure provides an interactive display system, which includes an interactive controller and an interactive display module. The interactive controller includes a plurality of marking patterns. The marking patterns are presented on a surface of the interactive controller. The interactive display module includes a display, an image capturing device and a processor. The image capturing device captures a marking image of the marking patterns. The processor is coupled to the display and the image capturing device. The processor obtains location information of the interactive controller, calculates a directional angle of the interactive controller according to a relative position relationship of the marking patterns in the marking image, and calculates a directional coordinate of the interactive controller according to the directional angle and the location information. The display displays an indication object at a position associated with the directional coordinate.

An embodiment of the disclosure provides a control method of interactive display, which is adapted to an interactive display system including an interactive controller and a display. The control method includes following steps: capturing a marking image of a plurality of marking patterns presented on the interactive controller; obtaining location information of the interactive controller; calculating a directional angle of the interactive controller according to a relative position relationship of the marking patterns in the marking image; calculating a directional coordinate of the interactive controller according to the directional angle and the location information; and displaying an indication object at a position associated with the directional coordinate on the display.

In order to make the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a block diagram of an interactive display system according to an embodiment of the disclosure.

FIG. 2 is a schematic diagram of an interactive display system according to an embodiment of the disclosure.

FIG. 3 is a flowchart illustrating a control method of interactive display according to an embodiment of the disclosure.

FIG. 4 is a block diagram of an interactive display system according to an embodiment of the disclosure.

FIG. 5 is a schematic diagram of an interactive display system according to an embodiment of the disclosure.

FIG. 6 is a flowchart illustrating a control method of interactive display according to an embodiment of the disclosure.

FIG. 7 is a block diagram of an interactive display system according to an embodiment of the disclosure.

FIG. 8 is a flowchart illustrating a control method of interactive display according to an embodiment of the disclosure.

FIG. 9A and FIG. 9B are schematic diagrams of an interactive controller and a marking image according to an embodiment of the disclosure.

FIG. 10A and FIG. 10B are schematic diagrams of an interactive controller and a marking image according to an embodiment of the disclosure.

FIG. 11 is a schematic diagram of calculating a directional coordinate and displaying an indication object according to an embodiment of the disclosure.

### DESCRIPTION OF EMBODIMENTS

Reference will now be made in detail to the present embodiments of the disclosure, examples of which are illustrated in the accompanying drawings. Wherever possible, the same reference numbers are used in the drawings and the description to refer to the same or like parts. Theses exemplary embodiments are only a part of the disclosure, and the disclosure does not disclose all of the implementations. More precisely, these exemplary embodiments are only examples of the system and method in the claims of the disclosure.

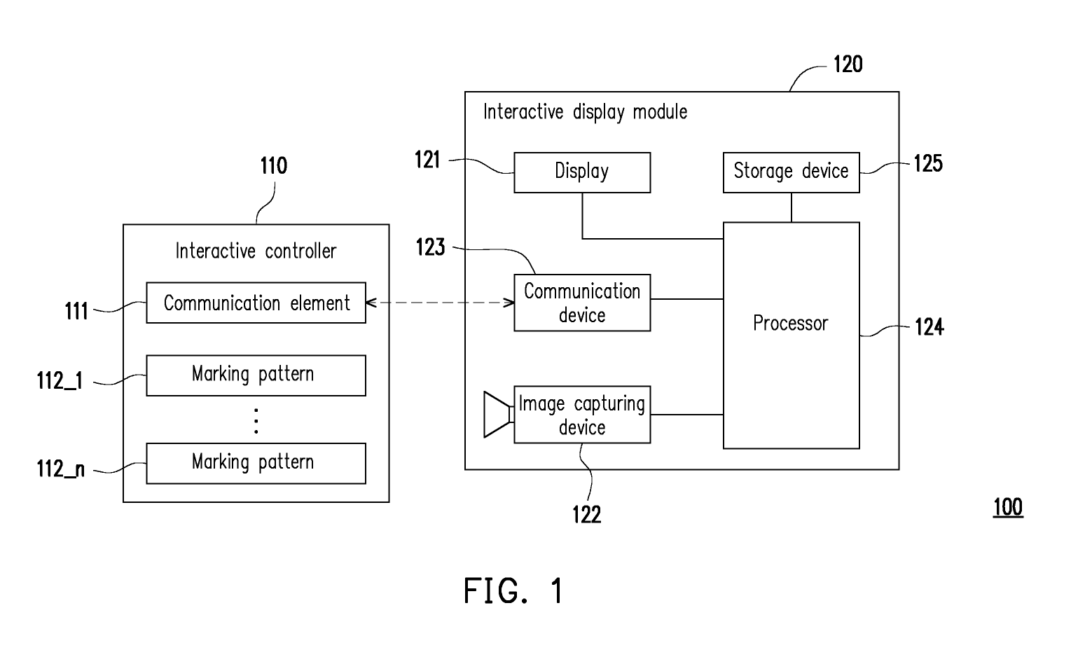

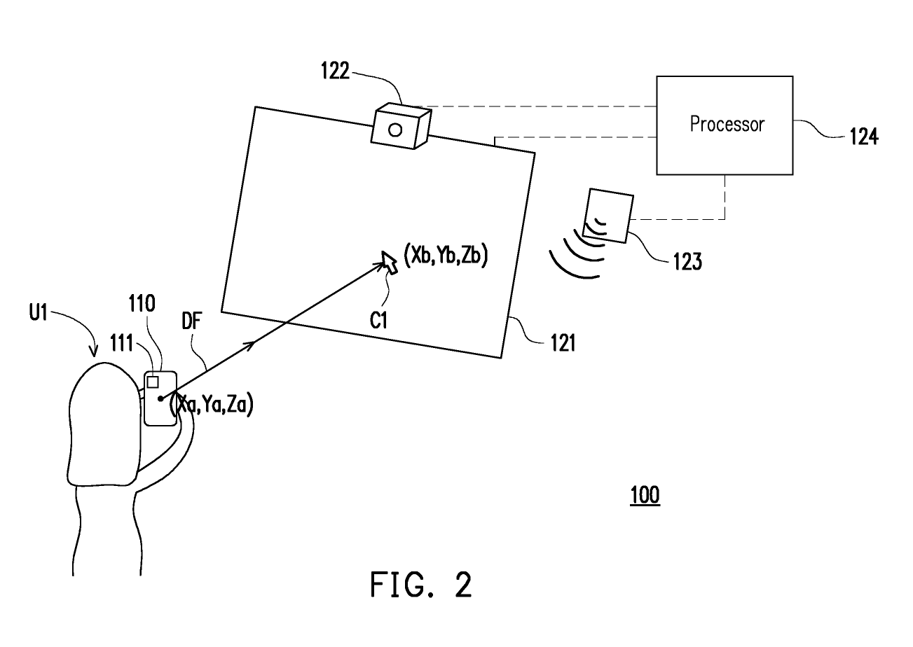

FIG. 1 is a block diagram of an interactive display system according to an embodiment of the disclosure. FIG. 2 is a schematic diagram of an interactive display system according to an embodiment of the disclosure. Referring to FIG. 1 and FIG. 2, the interactive display system 100 includes an interactive controller 110 and an interactive display module 120. As shown in FIG. 2, a user U1 may hold the interactive controller 110 to interact with the interactive display module 120, so as to drive the interactive display module 120 to provide a corresponding display effect and content according to a gesture of the user U1 holding the interactive controller 110. However, FIG. 2 is only an exemplary explanation, which is not used for limiting the disclosure. In another embodiment, the user U1 may also control the interactive controller 110 through remote control or other control method, so as to interact with the interactive display module 120, which is not limited by the disclosure. In the present embodiment, the interactive controller 110 includes a communication element 111 and a plurality of marking patterns 112_1-112_n. The interactive display module 120 includes a display 121, an image capturing device 122, a communication device 123 and a processor 124.

The marking patterns 112_1-112_n are presented on a surface of the interactive controller 110, and are, for example, distributed in a predetermined configuration. In an embodiment, the interactive controller 110 may be implemented as a card-type carrier, and the marking patterns 112_1-112_n are printed on the card-type carrier. The marking patterns 112_1-112_n may be previously printed on the card-type carrier having no electronic power supply. In an embodiment, the interactive controller 110 may be a handheld electronic device having electronic power supply, such as a smart phone, a tablet and so on, and a screen of the handheld electronic device may display the marking patterns 112_1-112_n. In an embodiment, the marking patterns 112_1-112_n may be printed on an adhesive carrier or displayed on an electronic paper, and the interactive controller 110 may be an object adhered with the above adhesive carrier (for example, a sticker or the electronic paper). Moreover, the number of the marking patterns 112_1-112_n may be three or more, and a geometric shape may be formed by connecting the marking patterns 112_1-112_n based on distribution positions thereof. For example, three marking patterns 112_1-112_n may be respectively vertices of a triangle, and four marking patterns 112_1-112_n may be respectively vertices of a quadrilateral, which is not limited by the disclosure.

In an embodiment of the disclosure, by applying a wireless positioning technique in the interactive display system 100, location information of the interactive controller 110 is generated. The above location information may be a positioning location of the interactive controller 110 or relative location information between the interactive controller 110 and a reference object. The aforementioned wireless positioning technique may be a GPS positioning technique, an infrared positioning technique, a Bluetooth positioning technique, an ultrasound positioning technique, a Zigbee positioning technique, a WiFi positioning technique, an iBeacon positioning technique, a cellular communication positioning technique, an ultra wideband positioning technique, or a radio frequency identification (RFID) positioning technique, which is not limited by the disclosure.

The communication element 111 may generate a wireless signal for communicating with the interactive display module 120. Communication standards supported by the communication element 111 may include a RFID standard, a Bluetooth standard, a WiFi standard, a Zigbee standard, etc., or a combination thereof. In an embodiment, the communication element 111 may directly transmit the location information of the interactive controller 110 to the interactive display module 120 through transmission of the wireless signal. For example, the interactive controller 110 first learns its own location information based on one of the aforementioned positioning techniques, and transmits the location information to the interactive display module 120 through the communication element 111. In an embodiment, the communication element 111 may transmit a wireless signal used for positioning to the interactive display module 120, and the interactive display module 120 performs positioning according to the wireless signal transmitted from the communication element 111 to obtain the location information of the interactive controller 110. For example, the communication element 111 may produce a RFID signal, and the interactive display module 120 receives the RFID signal through the communication device 123. The interactive display module 120 performs positioning according to the RFID signal to learn the location information of the interactive controller 110.

The display 121 is used for displaying images, and is adapted to display an indication object according to a location and a placing manner of the interactive controller 110. The display 121 is, for example, a liquid crystal display (LCD), a light-emitting diode (LED) display (which includes an inorganic LED display or an organic LED display), a projection display or other types of displays. In an embodiment, the display 121 may be a transparent display. The transparent display refers to that the display itself has a certain degree of light transmittance, and is adapted to present a background behind the display. The display 121 implemented as the transparent display may be adapted to various applications such as view windows of buildings (for example, observation decks, aquariums, museums), exhibition windows, vehicle glass serving as a display, etc.

The image capturing device 122 captures a marking image of the marking patterns 112_1-112_n, and includes a camera lens having a lens and a photosensing device. The photosensing device is used for sensing a light intensity entering the lens to produce an image. The photosensing device is, for example, a charge coupled device (CCD), a complementary metal-oxide semiconductor (CMOS) device or other devices, which is not limited by the disclosure.

The communication device 123 is used for communicating with the communication element 111, and receives the wireless signal generated by the communication element 111. The communication standards supported by the communication device 123 may include the RFID standard, the Bluetooth standard, the WiFi standard, the Zigbee standard, etc., or a combination thereof. For example, the communication device 123 may be a RFID radar, a WiFi access point, etc.

The storage device 125 is used for storing data such as images, programs, etc., which is, for example, any type of a fixed or movable random access memory (RAM), a read-only memory (ROM), a flash memory, a hard drive or other similar device, an integrated circuit and a combination thereof.

The processor 124 is coupled to the display 121, the image capturing device 122, the communication device 123 and the storage device 125. The processor 124 may be implemented by at least one of a system on chip (SOC), a field programmable gate array (FPGA) chip, a complex programmable logic device (CPLD), a microprocessor, a central processor (CPU), or other hardware device having the computation capability.

Referring to FIG. 2, the image capturing device 122 may capture/photograph an image of the marking patterns 112_1-112_n on the interactive controller 110 towards a display direction of the display 121 to generate a marking image. The marking patterns 112_1-112_n may be presented on the surface of the interactive controller 110 in a predetermined configuration, and the processor 124 may analyze the aforementioned marking image to obtain a pointing direction DF of the interactive controller 110. In an embodiment, the pointing direction of the interactive controller 110 may be a normal direction of the surface presenting the marking patterns 112_1-112_n. On the other hand, through the wireless signal transmission between the communication element 111 and the communication device 123, the processor 124 may obtain the location information of the interactive controller 110, for example, a coordinate location (Xa, Ya, Za) shown in FIG. 2. Therefore, the processor 124 may calculate a directional coordinate (Xb, Yb, Zb) of the interactive controller 110 projected on the display 121 according to the location information and the pointing direction DF of the interactive controller 110, and control the display 121 to display an indication object C1 at a position associated with the directional coordinate (Xb, Yb, Zb). The indication object C1 may be a display object such as a cursor, a marking point, an information display column, etc., which is not limited by the disclosure.

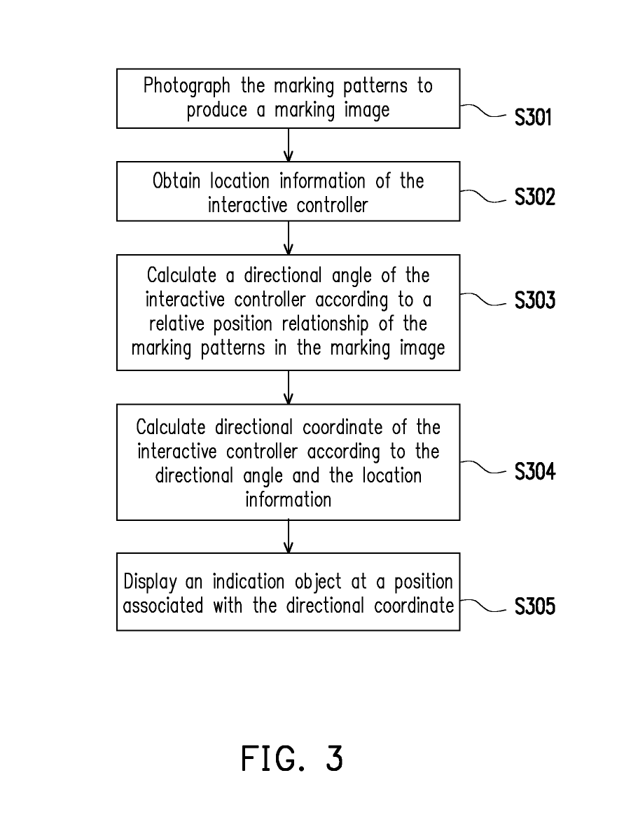

FIG. 3 is a flowchart illustrating a control method of interactive display according to an embodiment of the disclosure. The method flow of FIG. 3 may be implemented by the interactive display system 100 shown in FIG. 1 and FIG. 2.

Referring to FIG. 1 and FIG. 3, in step S301, the image capturing device 122 photographs the marking patterns 112_1-112_n to generate a marking image. The marking image records image objects of the marking patterns 112_1-112_n. In step S302, the processor 124 obtains location information of the interactive controller 110. The location information may be a location coordinate of the interactive controller 110 or a distance between the interactive controller 110 and a display plane of the display 121. In step S303, the processor 124 calculates a directional angle of the interactive controller 110 according to a relative position relationship of the marking patterns 112_1-112_n in the marking image. The relative position relationship of the marking patterns 112_1-112_n in the marking image is determined according to a gesture of the user U1 holding the interactive controller 110. By analyzing and comparing the relative position relationship of the marking patterns 112_1-112_n in the marking image and location information of the predetermined configuration of the marking patterns 112_1-112_n on the interactive controller 110, the processor 124 may calculate the directional angle of the interactive controller 110. In step S304, the processor 124 calculates a directional coordinate of the interactive controller 110 according to the directional angle and the location information. In case that the directional angle and the location information are obtained, the processor 124 may calculate the directional coordinate projected on the display plane by projecting a reference point on the interactive controller 110 to the display plane along the normal direction of the surface of the interactive controller 110, where the surface of the interactive controller 110 is the surface presenting the marking patterns 112_1-112_n and facing the display 121. In step S305, the display 121 displays an indication object at a position associated with the directional coordinate. In this way, by holding the interactive controller 110 and controlling a facing direction of the surface of the interactive controller 110, the user U1 may interact with the interactive display module 120, such that the display 121 may correspondingly provide a display effect and/or content according to a placing state of the interactive controller 110. The interactive display system of an embodiment of the disclosure may provide a display interaction with high sensitivity, which avails compensating insufficiency of an eye tracking technique or a touch control technique limited by the distance.

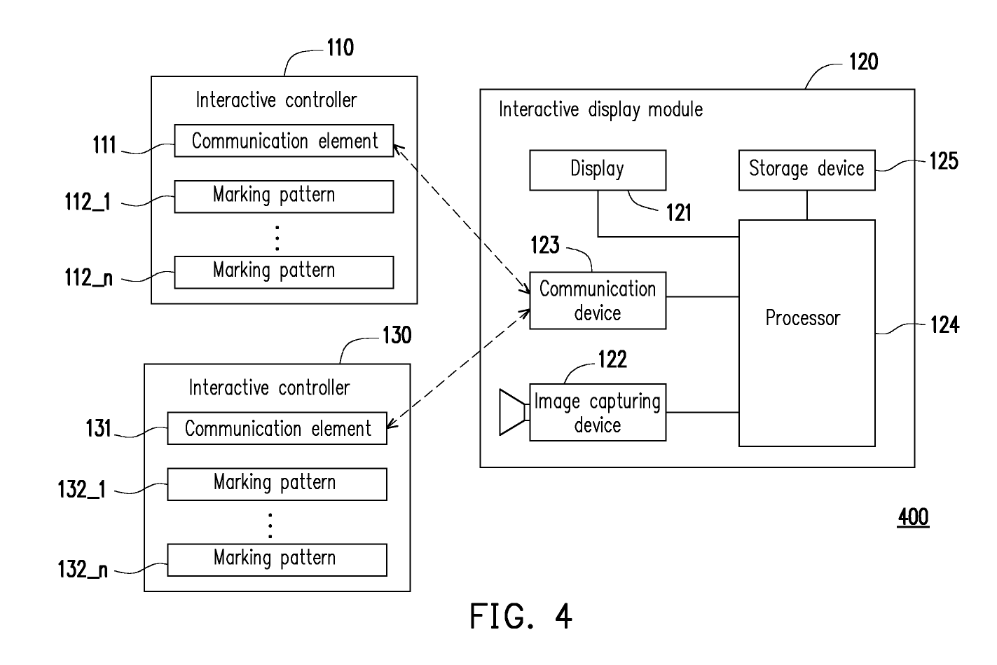

However, although one interactive controller 110 is taken as an example for description in the aforementioned embodiment, the disclosure does not limit the number of the interactive controllers 110 in the interactive display system 100. In an embodiment, the number of the interactive controllers may be two or more, and the display may correspondingly display a plurality of indication objects based on the interactive controllers detected by the system. FIG. 4 is a block diagram of an interactive display system 400 according to an embodiment of the disclosure. Referring to FIG. 4, the interactive display system 400 includes the interactive controller 110, an interactive controller 130 and the interactive display module 120. Operations and functions of the interactive controller 110 and the interactive display module 120 are similar to that of the embodiment of FIG. 1, and details thereof are not repeated. It should be noted that the interactive display system 400 further includes the interactive controller 130, and the interactive controller 130 includes a communication element 131 and a plurality of marking patterns 132_1-132_n.

The communication element 131 may communicate with the communication device 123, and the image capturing device 122 photographs the marking patterns 132_1-132_n to generate a marking image. In an embodiment, the marking image may simultaneously records a marking image including image objects of the marking patterns 112_1-112_n and the marking patterns 132_1-132_n. The processor 124 may calculate a directional coordinate of the interactive controller 130 according to another directional angle and another location information of the interactive controller 130, and the display 121 may display another indication object at a position associated with the directional coordinate of the interactive controller 130. Namely, besides that the processor 124 may calculate the directional coordinate of the interactive controller 110, the processor 124 may further obtain the directional coordinate of the interactive controller 130 according to the similar operation and calculation methods. The processor 124 may display different indication objects according to the gestures of different users (the user U1 and other user) respectively holding the interactive controller 110 and the interactive controller 130. Namely, the interactive display system 400 of the disclosure is adapted to an information display service of multi-user interaction.

In an embodiment, the interactive controller 110 may further include an input element (not shown) for receiving the operation of the user U1, such that the interactive display module 120 may display a display function according to a control command produced in response to the operation of the user U1. The input element may be a physical button, a virtual button displayed on a touch screen or other software/hardware device capable of receiving the operation of the user U1. The processor 124 of the interactive display module 120 may determine whether to display the indication object or further display other related content according to the control command sent by the interactive controller 110. In an embodiment, the input element may be a RFID tag, and the interactive controller 110 generates the control command according to a signal state of a radio frequency signal received by the input element.

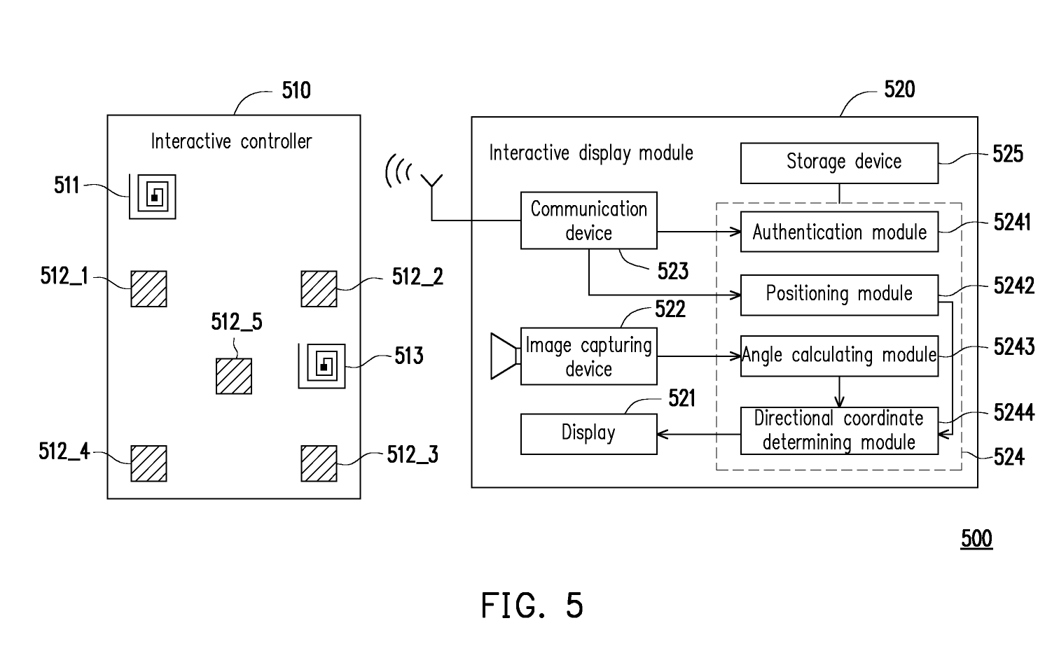

An embodiment is provided below to describe an example that an interactive display system of the disclosure uses the RFID technique. FIG. 5 is a schematic diagram of an interactive display system 500 according to an embodiment of the disclosure. Referring to FIG. 5, the interactive display system 500 includes an interactive controller 510 and an interactive display module 520. In the present embodiment, the interactive controller 510 includes a communication element 511, an input element 513 and 5 marking patterns 512_1-512_5. In the present embodiment, the communication element 511 and the input element 513 may be RFID tags, which are composed of coil antennas and chips having a storage function. When the communication element 511 and the input element 513 are passive RFID tags, the communication element 511 and the input element 513 may transmit back wireless signals through electromagnetic waves sent by a communication device 523. Moreover, the communication element 511 and the input element 513 may also be active RFID tags, and have the ability to actively generate and send wireless signals. When the communication element 511 and the input element 513 are active RFID tags, the interactive controller 510 may further include a power supply module (not shown) for providing power to the active RFID tags. The power supply module of the interactive controller 510 may include a piezoelectric module, a battery, a wireless charging module, etc., though the disclosure is not limited thereto.

In the example of FIG. 5, the marking patterns 512_1-512_4 are presented on a surface of the interactive controller 510 and arranged in a rectangle, and the marking pattern 512_5 is located at a center position of the rectangle formed by the marking patterns 512_1-512_4. Namely, distances between each of the marking patterns 512_1-512_5 and a relative position relationship thereof are determined by the predetermined configuration. Moreover, in the present embodiment, each of the marking patterns 512_1-512_5 has a block pattern with the same size and the same shape, though the disclosure is not limited thereto. The shape and size of each of the marking patterns 512_1-512_5 may be designed according to an actual application.

On the other hand, the interactive display module 520 includes a display 521, an image capturing device 522, a communication device 523, a storage device 525 and a processor 524. The communication device 523 is used for communicating with the RFID tags (i.e. the communication element 511 and the input element 513), which is, for example, a RFID radar or a RFID reader. Moreover, the processor 524 in the interactive display system 500 is divided into a plurality of function modules for description, and these function modules may be implemented by software in collaboration with the processor 524, and may also be directly implemented by hardware circuits having the same functions with the function modules to form the processor 524. The processor 524 may be applied to each of the embodiments of the disclosure according to an actual requirement.

The input element 513 may serve as an element for receiving an input operation of the user U1. In the present embodiment, when a finger of the user U1 is placed on the input element 513, the RFID signal transceived by the input element 513 is interfered. When the RFID signal transceived by the input element 513 is interfered, the interactive controller 510 may take it as an input signal, and further let the interactive display module 520 to receive the control command sent by the user U1. For example, by detecting a signal strength of the RFID signal transceived by the input element 513, the interactive controller 510 may determine whether receiving a command issued by the user U1 or not. Then, the interactive display module 520 may execute a display interactive function according to the control command issued by the user U1 and the directional coordinate. For example, when the user U1 puts the finger on the input element 513, the display 521 displays an indication object according to the directional coordinate. Otherwise, the display 521 does not display the indication object.

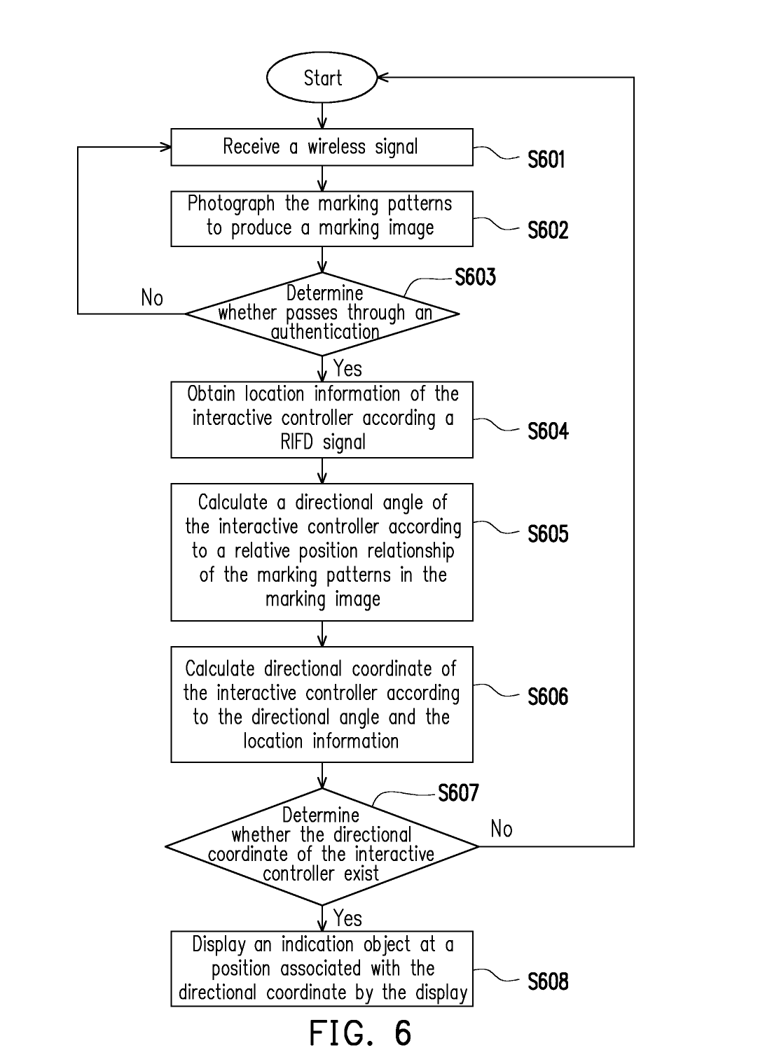

FIG. 6 is a flowchart illustrating a control method of interactive display according to an embodiment of the disclosure. The method flow of FIG. 6 may be implemented by the interactive display system 500 shown in FIG. 5.

Referring to FIG. 5 and FIG. 6, in step S601, the communication device 523 receives a wireless signal generated by the communication element 511, and in the present embodiment, a RFID signal is taken as an example for description. In step S602, the image capturing device 522 photographs the marking patterns 512_1-512_5 to generate a marking image. In step S603, an authentication module 5241 determines whether the interactive controller 510 passes through an authentication according to the RFID signal.

The authentication module 5241 of the processor 524 may determine whether the interactive controller 510 passes through the authentication according to an identification code carried a wireless signal transmitted by the RFID tag (i.e., the communication element 511). Only the authenticated interactive controller 510 has a permission of controlling the interactive display module 520 to perform interactive display. When the interactive controller 510 does not pass through the authentication, the processor 524 does not subsequently calculate the directional coordinate of the interactive controller 510. When the interactive controller 510 passes through the authentication, the processor 524 further executes related calculation of the directional coordinate. In the embodiment of FIG. 6, if the determination result of the step S603 is affirmative (passing through the authentication), in step S604, a positioning module 5242 obtains location information of the interactive controller 510 according to the RFID signal. The positioning module 5242 may receive the location information transmitted through the wireless signal, or position the interactive controller 510 according to the wireless signal received by the communication device 523 to obtain the location information of the interactive controller 510. Otherwise (not passing through the authentication), the flow returns back to the step S601 to continually detect and receive the RFID signal.

Then, in step S605, an angle calculating module 5243 calculates a directional angle of the interactive controller 510 according to a relative position relationship of the marking patterns 512_1-512_5 in the marking image. In step S606, a directional coordinate determining module 5244 calculates a directional coordinate of the interactive controller 510 according to the directional angle and the location information. In step S607, the directional coordinate determining module 5244 determines whether the directional coordinate of the interactive controller 510 exist. The directional coordinate determining module 5244 of the processor 524 may determine whether the directional coordinate of the interactive controller 510 exist according to whether the directional coordinate is within a predetermined range. The aforementioned predetermined range is a display range of the display plane of the display 521. When it is determined that the directional coordinate is within the display range, it represents that the directional coordinate exist, and the directional coordinate determining module 5244 controls the display 521 to display an indication object at a position associated with the directional coordinate. Namely, if the determination result of the step S607 is affirmative, in step S608, the display 521 displays an indication object at a position associated with the directional coordinate. Otherwise, when it is determined that the directional coordinate is outside the display range, it represents that the directional coordinate do not exist, and the directional coordinate determining module 5244 controls the display 521 not to display the indication object, and the flow of FIG. 6 is re-executed.

It should be noted that the flow of FIG. 6 is only an example, and an execution sequence of the steps S602-S605 is not limited by the disclosure. For example, in an embodiment, the authentication of the step S603 may be executed after the step of calculating the directional angle or obtaining the location information, or the step S604 and the step S605 may be parallel executed at the same time. Moreover, in an embodiment, when one of the location information, the directional angle and the directional coordinate cannot be obtained, the interactive display module 520 may execute the flow of FIG. 6 from the beginning to keep detecting the state of the interactive controller 510 operated by the user.

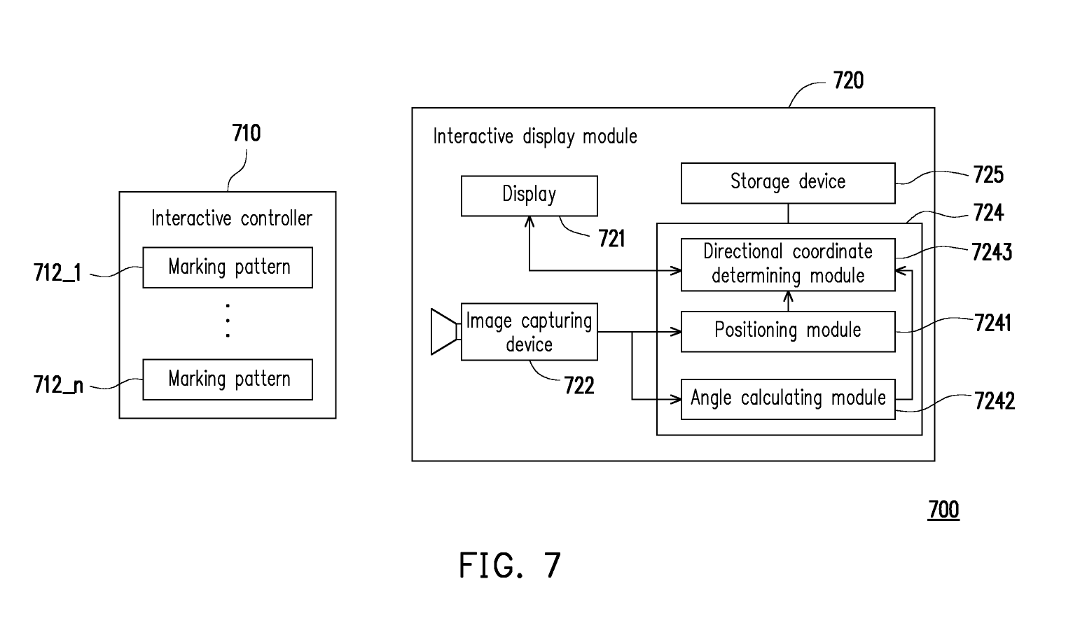

In the aforementioned embodiments, the location information of the interactive controller is detected by using the communication technique. However, in other embodiments of the disclosure, the location information of the interactive controller may be obtained through the image capturing device and image analysis, which is described below in another embodiment. FIG. 7 is a block diagram of an interactive display system 700 according to an embodiment of the disclosure. Referring to FIG. 7, the interactive display system 700 includes an interactive controller 710 and an interactive display module 720. The interactive controller 710 includes a plurality of marking patterns 721_1-721_n, and the marking patterns 721_1-721_n are presented on a surface of the interactive controller 710. The interactive display module 720 includes a display 721, an image capturing device 722, a processor 724 and a storage device 725. The processor 724 in the interactive display system 700 is divided into a plurality of function modules for description, and these function modules may be implemented by software in collaboration with the processor 724, and may also be directly implemented by hardware circuits having the same functions with the function modules to form the processor 724.

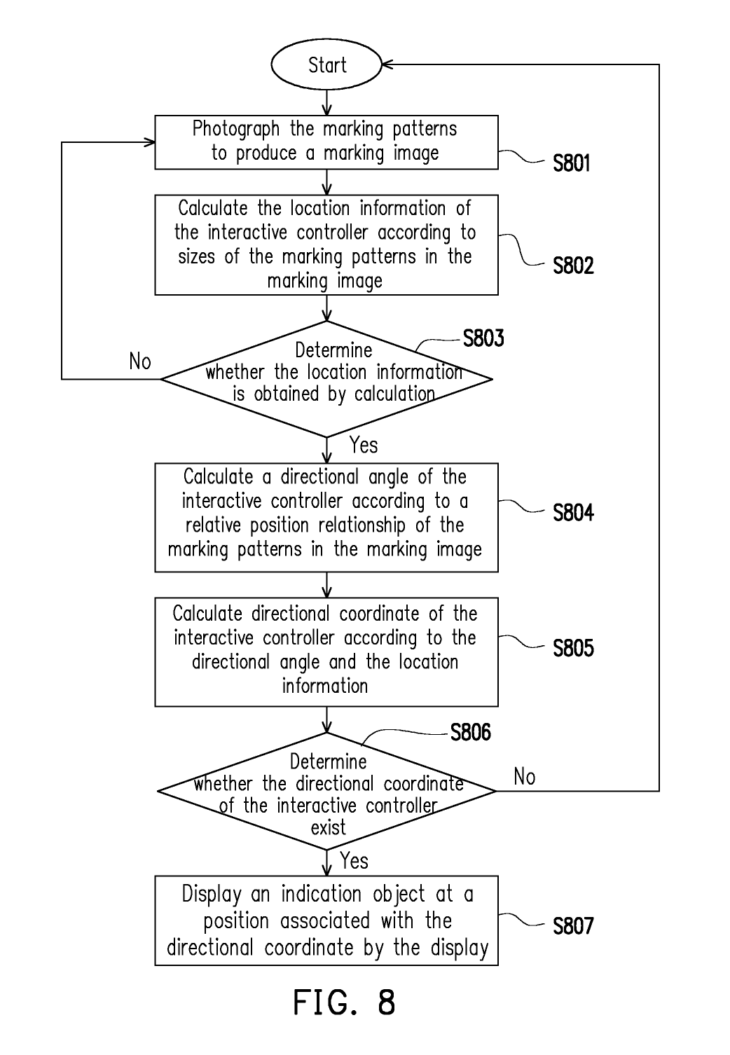

FIG. 8 is a flowchart illustrating a control method of interactive display according to an embodiment of the disclosure. The method flow of FIG. 8 may be implemented by the interactive display system 700 shown in FIG. 7.

Referring to FIG. 7 and FIG. 8, in step S801, the image capturing device 722 captures a marking image of the marking patterns 712_1-712_n. In step S802, a positioning module 7241 calculates the location information of the interactive controller 710 according to sizes of the marking patterns 712_1-712_n in the marking image. A position of the image capturing device 722 is fixed, and actual sizes of the marking patterns 712_1-712_n is known, and by comparing the sizes of the marking patterns 712_1-712_n in the marking image with the actual sizes of the marking patterns 712_1-712_n, the positioning module 7241 may estimate a distance between the interactive controller 710 and the display plane of the display 721. Moreover, in an embodiment, according to the above distance and the positions of the marking patterns 712_1-712_n in the marking image, the positioning module 7241 may further calculate a position of the interactive controller 710 under a predetermined coordinate system.

In step S803, the positioning module 7241 determines whether the location information is calculated, and if a determination result of the step S803 is affirmative, in step S804, an angle calculating module 7242 calculates a directional angle of the interactive controller 710 according to a relative position relationship of the marking patterns 712_1-712_n in the marking image, and if the determination result of the step S803 is negative, the flow returns back to the step S801. In step S805, a directional coordinate determining module 7243 calculates a directional coordinate of the interactive controller 710 according to the directional angle and the location information. In step S806, the directional coordinate determining module 7243 determines whether the directional coordinate of the interactive controller 710 exist. In step S807, the display 721 displays an indication object at a position associated with the directional coordinate. Otherwise, when it is determined that the directional coordinate do not exist, the flow of FIG. 8 is re-executed.

It should be noted that the flow of FIG. 8 is only an example, and an execution sequence of the steps S802-S804 is not limited by the disclosure. Moreover, in an embodiment, when one of the location information, the directional angle and the directional coordinates cannot be obtained, the interactive display module 720 may execute the flow of FIG. 8 from the beginning to keep detecting the state of the interactive controller 710 operated by the user.

In following description, calculation of the directional angle according to the marking patterns in the marking image is further described below. When a facing direction of the surface of the interactive controller is changed, the relative position relationship of the marking patterns in the marking image is also changed. As the positions of the marking patterns on the interactive controller are pre-configured, by analyzing the relative position relationship of the marking patterns in the marking image, it may be determined whether the surface presenting the marking patterns directly faces the display plane or further calculate a pointing direction of the surface presenting the marking patterns. The above relative position relationship may be relative distances between these marking patterns in the marking image. In an embodiment, the processor may calculate the directional angle of the interactive controller according to a first relative distance between a first position of a first marking pattern in the marking image and a second position of a second marking pattern in the marking image. For example, it is assumed that the marking patterns are configured on the interactive controller in a manner of constructing a regular polygon, by determining whether relative distances between marking patterns in the marking image are equivalent, the processor may determine whether the surface presenting the marking pattern directly faces the display. In an embodiment, the processor may further compare an actual distance with the aforementioned first relative distance to calculate the directional angle, and the actual distance is a distance actually spaced between two marking patterns on the interactive controller.

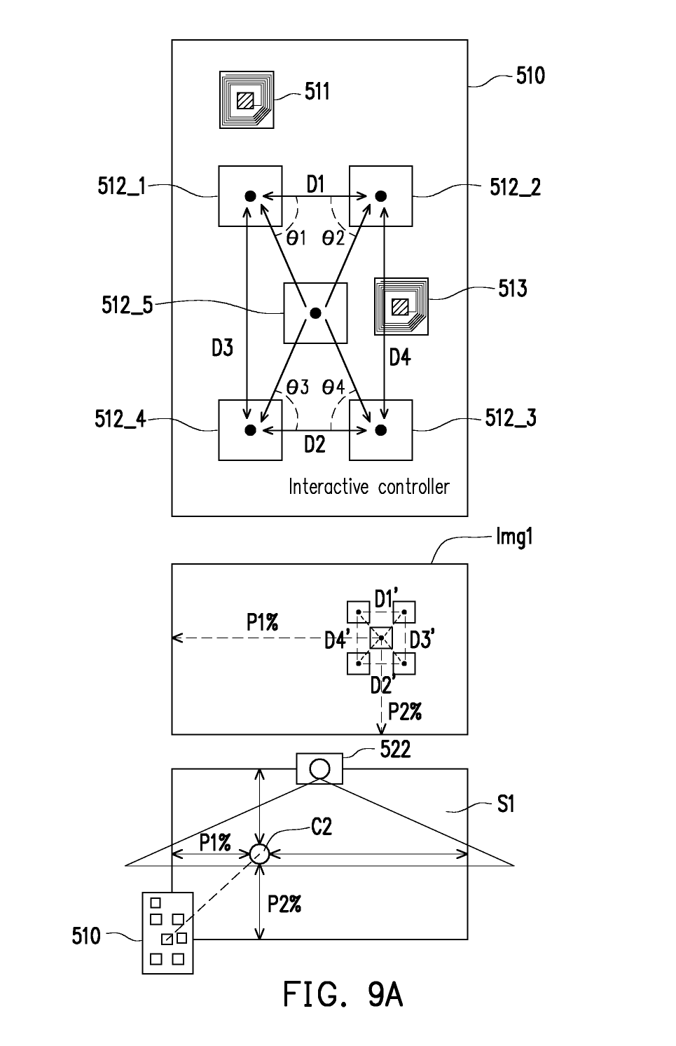

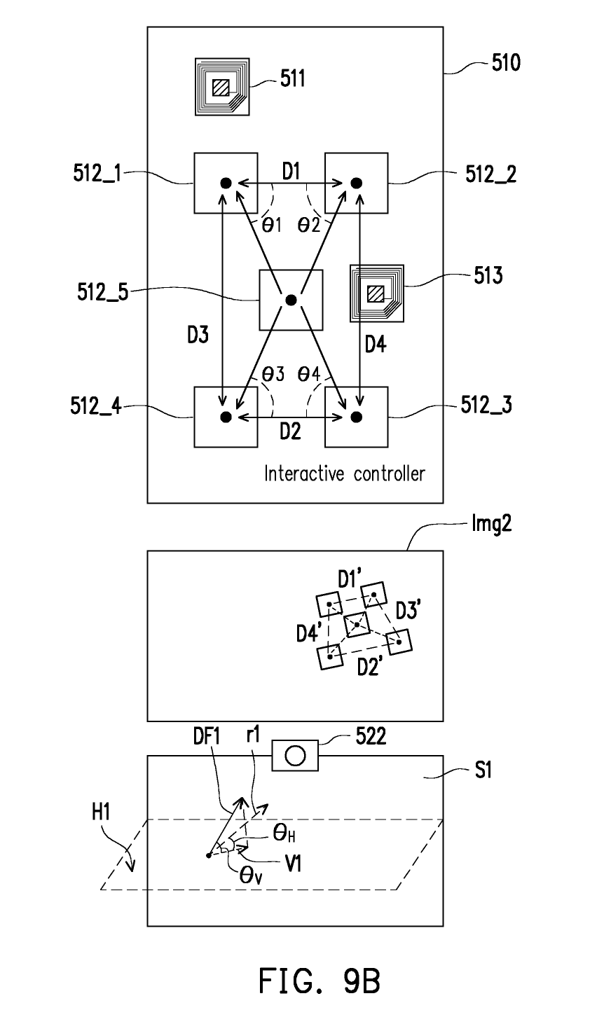

The interactive controller 510 of FIG. 5 is taken as an example to describe how to calculate the pointing direction. FIG. 9A and FIG. 9B are schematic diagrams of an interactive controller 510 and a marking image according to an embodiment of the disclosure. Referring to FIG. 9A and FIG. 9B, the marking patterns 512_1-512_5 are configured on the surface of the interactive controller 510 according to a predetermined configuration, and the relative position relationship between the marking patterns 512_1-512_5 may be pre-calculated and stored. Namely, an actual distance D3 between the marking pattern 512_1 and the marking pattern 512_4 and an actual distance D1 between the marking pattern 512_1 and the marking pattern 512_2 are pre-recorded fixed information, and an actual distance D2 between the marking pattern 512_3 and the marking pattern 512_4 and an actual distance D4 between the marking pattern 512_3 and the marking pattern 512_2 are pre-recorded fixed information.

Referring to FIG. 9A, in an embodiment, when a distance D3′ between the marking pattern 512_1 and the marking pattern 512_4 in a marking image Img1 is the same to a distance D4′ between the marking pattern 512_2 and the marking pattern 512_3 in the marking image Img1, and a distance D1′ between the marking pattern 512_1 and the marking pattern 512_2 in the marking image Img1 is the same to a distance D2′ between the marking pattern 512_4 and the marking pattern 512_3 in the marking image Img1, the angle calculating module 5243 determines that the interactive controller 510 directly faces the display 521, i.e. the pointing direction of the interactive controller 510 is perpendicular to the display plane of the display 521. In this case, by analyzing a distance ratio P1% between the marking pattern 512_5 in the marking image Img1 and an image left margin and a distance ratio P2% between the marking pattern 512_5 and an image lower margin, the directional coordinate determining module 5244 may calculate the directional coordinate of the interactive controller 510 according to the above distance ratios, so as to control the display 521 to display an indication object C2 on the display plane S1 according to the directional coordinate. The aforementioned distance ratio P1% is a ratio between a distance of the marking pattern 512_5 in the marking image Img1 and the image left margin and a whole image width. The aforementioned distance ratio P2% is a ratio between a distance of the marking pattern 512_5 in the marking image Img1 and the image lower margin and a whole image height.

Referring to FIG. 9B, in an embodiment, when a marking image Img2 is captured, the angle calculating module 5243 may calculate a relative distance D3′ between the marking pattern 512_1 and the marking pattern 512_4 in the marking image Img2, and calculate a relative distance D1′ between the marking pattern 512_1 and the marking pattern 512_2 in the marking image Img2. Then, a vertical directional angle θ_{V} and a horizontal directional angle θ_{H} may be calculated according to the actual distance D1, the relative distance D1′, the actual distance D3, the relative distance D3′, as shown in following equations (1) and (2):

θ_{V}=cos⁻¹(D3′/D3) (1)

θ_{H}=cos⁻¹(D1′/D1) (2)

The normal direction DF1 of the surface of the interactive controller 510 may be determined according to the vertical directional angle θ_{V} and the horizontal directional angle θ_{H} as shown in FIG. 9B. It is noted that, the normal direction DF1 of the surface of the interactive controller 510 herein may be referring as the pointing direction DF of the interactive controller 510. The vertical directional angle θ_{V} is an included angle between a normal direction DF1 of the surface presenting the marking patterns 512_1-512_5 and a horizontal plane H1, and the horizontal directional angle θ_{H} is an included angle between a projection direction v1 of the normal direction DF1 projected on the horizontal plane H1 and a reference direction r1. Herein, the reference direction r1 is a direction point to the display, and is perpendicular to the display plane S1. Namely, the reference direction r1 may be a normal direction of the display plane S1. When the surface of the interactive controller 510 presenting the marking patterns 512_1-512_5 directly faces the display plane, which means the surface of the interactive controller 510 is parallel to the display plane S1, the vertical directional angle θ_{V} and the horizontal directional angle θ_{H} are respectively 0 degree. Afterword, based on the location information of the interactive controller 510, the vertical directional angle θ_{V} and the horizontal directional angle θ_{H}, the interactive display module 520 may obtain the directional coordinate of the interactive controller 510 projected to the display plane S1 along the pointing direction.

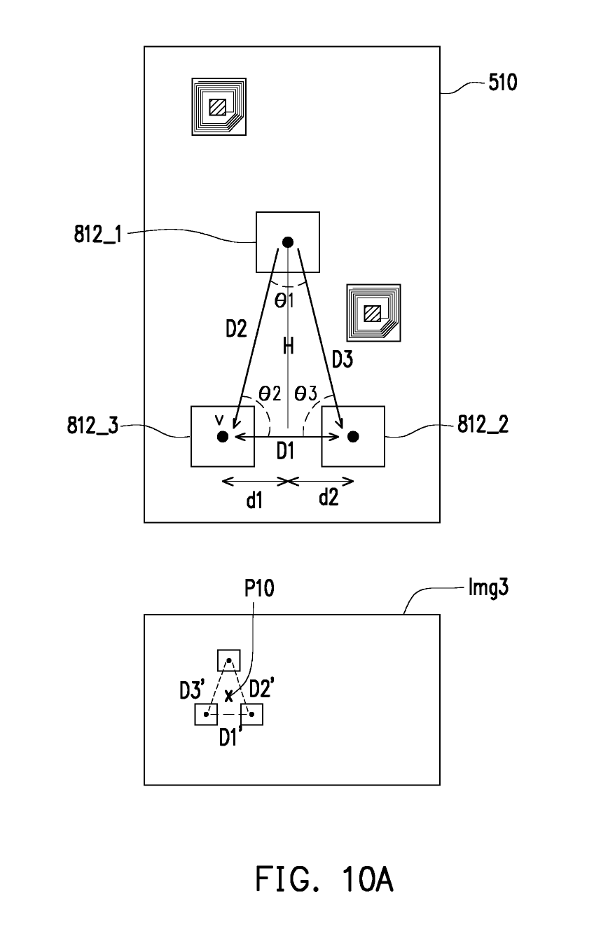

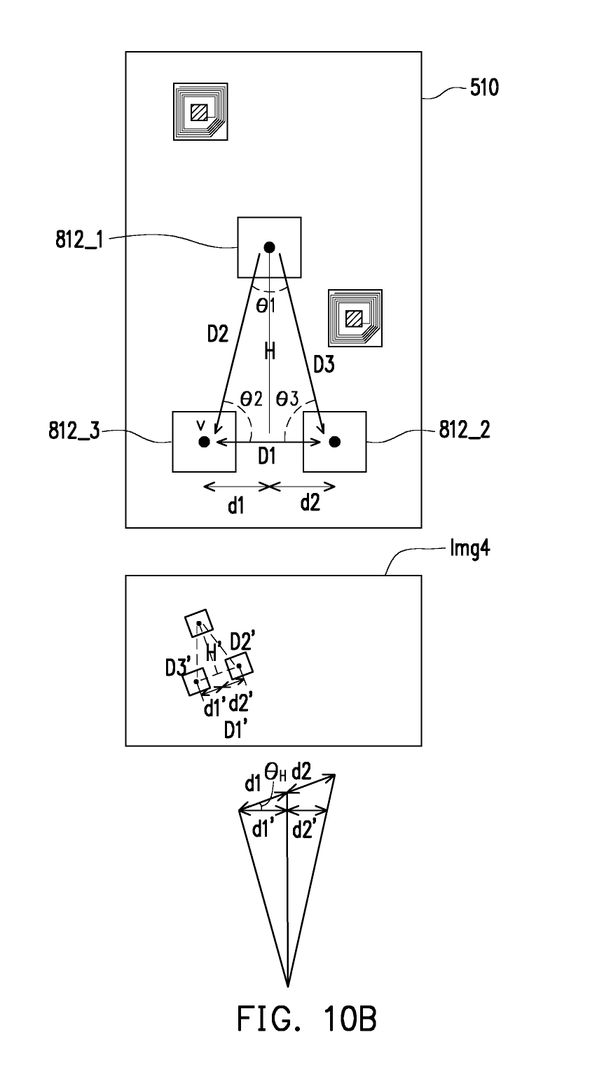

FIG. 10A and FIG. 10B are schematic diagrams of an interactive controller and a marking image according to an embodiment of the disclosure. Referring to FIG. 10A and FIG. 10B, the marking patterns 812_1-812_3 are configured on the surface of the interactive controller 510 according to a predetermined configuration, and the relative position relationship between the marking patterns 812_1-812_3 may be pre-calculated and stored. The marking patterns 812_1-812_3 may be respectively vertices of a triangle.

Namely, an actual distance D3 between the marking pattern 812_1 and the marking pattern 812_2, an actual distance D2 between the marking pattern 812_1 and the marking pattern 812_3, and an actual distance D1 between the marking pattern 812_2 and the marking pattern 812_3 are pre-recorded fixed information. In the present embodiment, the triangle constructed by the marking patterns 812_1-812_3 is, for example, an isosceles triangle, though the disclosure is not limited thereto.

Referring to FIG. 10A, when a ratio between a relative distance D2′ and a relative distance D1′ in the marking image Img3 and a ratio between a relative distance D3′ and the relative distance D1′ are the same with a predetermined ratio, it is determined that the surface presenting the marking patterns 812_1-812_3 directly faces the display plane. In this way, by averaging image coordinate positions of the three marking patterns 812_1-812_3 in the marking image Img3, a central reference point P10 is calculated. Similar to the embodiment of FIG. 9A, in case that the surface presenting the marking patterns 812_1-812_3 directly faces the display plane, which means the surface of the interactive controller 510 is parallel to the display plane, by analyzing the distance ratios between the central reference point P10 and margins of the marking image Img3, the directional coordinate of the interactive controller may be generated.

Moreover, referring to FIG. 10B, based on the actual distances D1, D2, D3, an actual height H and an actual bottom width W (W=D1−d1+d2) of the triangle are known, when a marking image Img4 is captured, a relative distance D2′ between the marking pattern 812_1 and the marking pattern 812_3 in the marking image Img4 is calculated, a relative distance D3′ between the marking pattern 812_1 and the marking pattern 812_2 in the marking image Img4 is calculated, and a relative distance D1′ between the marking pattern 812_3 and the marking pattern 812_2 in the marking image Img4 is calculated. A relative height H′ and a relative bottom width W′ (W′=D1′=d1′+d2′) in the marking image Img4 may be obtained according to the relative distances D1′, D2′, D3′. Then, by comparing a ratio between the actual height H and the actual bottom width W and a ratio between the relative height H′ and the relative bottom width W′, the vertical directional angle θ_{V} is deduced. Moreover, by comparing a ratio between the actual distance d1 and the actual distance d2 and a ratio between the relative distance d1′ and the relative distance d2′, the horizontal directional angle θ_{H} is deduced (as shown in FIG. 10B).

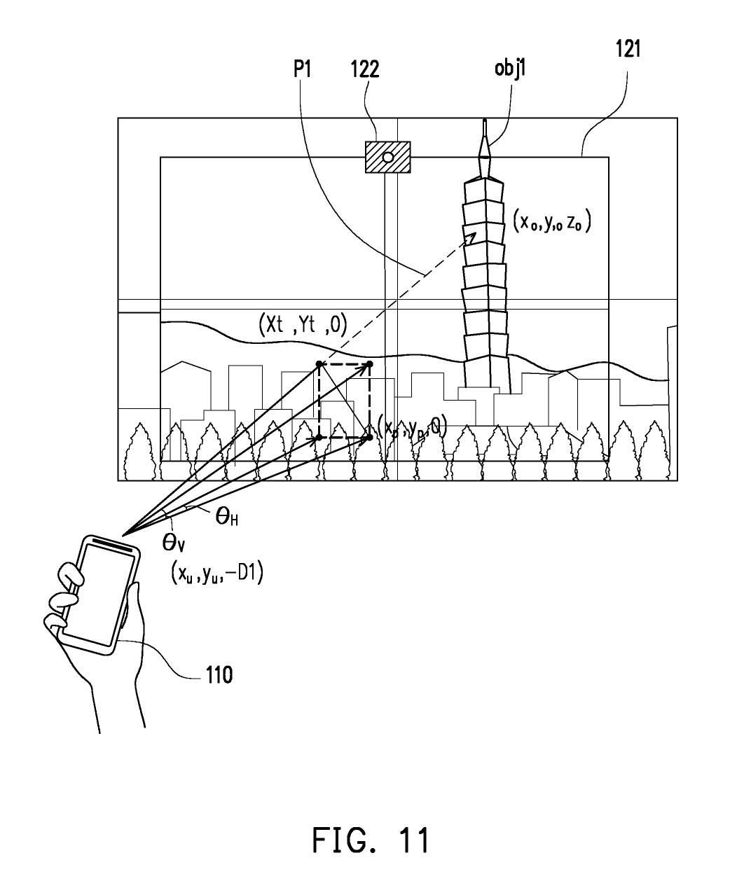

In an embodiment, the display is a transparent display, and after obtaining the directional coordinate projected on the display plane, the interactive display system of the disclosure may further identify a target object behind the transparent display indicated by the pointing direction, and display a corresponding indication information column on the transparent display according to the target object, which is described with reference of the interactive display system 100 of FIG. 1 and an embodiment of FIG. 11, and FIG. 11 is a schematic diagram of calculating a directional coordinate and displaying an indication object according to an embodiment of the disclosure. Referring to FIG. 11, first, the processor 124 obtains positioning coordinate (Xu, Yu, −D1) of the interactive controller 110 according to the RFID positioning technique. Then, the image capturing device 122 captures a marking image of the interactive controller 110, and the processor 124 may calculate a reference point (for example, a center point of one of the marking patterns) on the interactive controller 110 according to the marking image to obtain projection coordinate (Xp, Yp, 0). Then, the processor 124 may calculate a directional angle according to the marking image, i.e. the vertical directional angle θ_{V} and the horizontal directional angle θ_{H}, and calculates directional coordinate (Xt, Yt, 0) according to the vertical directional angle θ_{V} and the horizontal directional angle θ_{H}. Then, the processor 124 may produce an extending path P1 along the directional angle based on the directional coordinate (Xt, Yt, 0). In the present embodiment, the interactive display system 100 may further include a scene sensing device (not shown), and the scene sensing device may sense scenery objects behind the transparent display, and coordinate positions of each of the scenery objects may be detected and created in real-time. The processor 124 may compare the extending path P1 with the coordinate positions of the scenery objects to identify target coordinates (Xo, Yo, Zo). Then, the processor 124 obtains related information of a target object from the storage device 125 according to information of the target object corresponding to the target coordinate (Xo, Yo, Zo), and controls the display 121 to display the related information of the target object at a position associated with the directional coordinate (Xt, Yt, 0).

Moreover, the interactive display system of an embodiment of the disclosure may be further combined with a control method of the interactive controller and a plurality of other identification sensing techniques (for example, human eye tracking, touch control, image identification, etc.) to determine the scenery object to be viewed by the user or a position where the user wants to display the indication object, so as to improve identification correctness for user's operation intention.

In the embodiments of the disclosure, a plurality of marking patterns is configured to dispose on the surface of the interactive controller, and the image capturing device may photograph the marking patterns on the interactive controller to obtain the marking image. Therefore, the processor may analyze the marking image to obtain the directional coordinate of the interactive controller operated by the user, so as to improve identification correctness of the interactive display system for user's operation intention. In this way, the user may easily control the display to display the content interested by the user by controlling the interactive controller.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. An interactive display system, comprising:
an interactive controller, comprising:
a plurality of marking patterns, presented on a surface of the interactive controller; and
an interactive display module, comprising:
a display;
an image capturing device, photographing the marking patterns to generate a marking image; and
at least one processor, coupled to the display and the image capturing device, obtaining location information of the interactive controller, calculating a directional angle of the interactive controller according to a relative position relationship of the marking patterns in the marking image, and calculating a directional coordinate of the interactive controller according to the directional angle and the location information,
wherein the display displays an indication object at a position associated with the directional coordinate.

2. The interactive display system as claimed in claim 1, wherein the interactive controller further comprises a communication element generating a wireless signal, the interactive display module further comprises a communication device receiving the wireless signal, and the communication device is coupled to the processor,
wherein the processor receives the location information transmitted through the wireless signal, or positions the interactive controller according to the wireless signal received by the communication device, so as to obtain the location information of the interactive controller.

3. The interactive display system as claimed in claim 1, wherein the interactive controller further comprises a communication element generating a wireless signal, the interactive display module further comprises a communication device receiving the wireless signal, and the communication device is coupled to the processor,
wherein the processor determines whether the interactive controller passes through an authentication according to an identification code carried by the wireless signal; and when the interactive controller does not pass through the authentication, the processor does not calculate the directional coordinates of the interactive controller.

4. The interactive display system as claimed in claim 1, wherein the processor estimates a distance between the interactive controller and a display plane of the display by comparing sizes of the marking patterns in the marking image with actual sizes of the marking patterns, and calculates the location information according to the distance and positions of the marking patterns in the marking image.

5. The interactive display system as claimed in claim 1, wherein the interactive controller further comprises an input element used for receiving a user operation, the processor provides display content to the display according to a control command generated in response to the user operation.

6. The interactive display system as claimed in claim 5, wherein the input element is a radio frequency identification tag, and the interactive controller generates the control command according to a signal state of a radio frequency signal received by the input element.

7. The interactive display system as claimed in claim 1, wherein the processor determines whether the directional coordinate exist according to whether the directional coordinate is within a predetermined range; when the directional coordinate exist, the processor controls the display to display the indication object at the position associated with the directional coordinate; and when the directional coordinate do not exist, the processor controls the display not to display the indication object.

8. The interactive display system as claimed in claim 1, wherein a pointing direction corresponding to the directional angle is a normal direction perpendicular to the surface presenting the marking patterns, the marking patterns comprise a first marking pattern and a second marking pattern, and the processor calculates the directional angle of the interactive controller according to a first relative distance between a first position of the first marking pattern n the marking image and a second position of the second marking pattern in the marking image.

9. The interactive display system as claimed in claim 8, wherein the first marking pattern and the second marking pattern are spaced by an actual distance on the interactive controller, and the processor calculates the directional angle by comparing the actual distance with the first relative distance.

10. The interactive display system as claimed in claim 8, wherein the processor produces an extending path along the directional angle based on the directional coordinate, obtains target coordinate of a target object on the extending path, and controls the display to display content related to the target object according to the target coordinate.

11. The interactive display system as claimed in claim 1, further comprising another interactive controller, wherein the image capturing device captures the marking patterns and a plurality of other marking patterns of the another interactive controller to produce the marking image, the processor calculates other directional coordinate of the another interactive controller according to another directional angle and another location information of the another interactive controller, and the display further displays another indication object at a position associated with the other directional coordinate.

12. A control method of interactive display, adapted to an interactive display system comprising an interactive controller and a display, the control method of interactive display comprising:
photographing a plurality of marking patterns presented on the interactive controller to generate a marking image;
obtaining location information of the interactive controller;
calculating a directional angle of the interactive controller according to a relative position relationship of the marking patterns in the marking image;
calculating a directional coordinate of the interactive controller according to the directional angle and the location information; and
displaying an indication object at a position associated with the directional coordinate on the display.

13. The control method of interactive display as claimed in claim 12, further comprising:
receiving a wireless signal generated by the interactive controller; and
when the interactive control does not pass through an authentication, not to calculate the directional coordinate of the interactive controller.

14. The control method of interactive display as claimed in claim 12, further comprising:
determining whether the directional coordinate exist according to whether the directional coordinate is within a predetermined range; and
when the directional coordinate do not exist, not to display the indication object according to the directional coordinate.

15. The control method of interactive display as claimed in claim 12, wherein the step of obtaining the location information of the interactive controller comprises:
receiving a wireless signal generated by the interactive controller; and
receiving the location information transmitted through the wireless signal, or positioning the interactive controller according to the wireless signal received by the communication device, so as to obtain the location information of the interactive controller.

16. The control method of interactive display as claimed in claim 12, wherein the step of obtaining the location information of the interactive controller comprises:
estimating a distance between the interactive controller and a display plane of the display by comparing predetermined sizes of the marking patterns in the marking image with actual sizes of the marking patterns; and
calculating the location information according to the distance and positions of the marking patterns in the marking image.

17. The control method of interactive display as claimed in claim 12, wherein the marking patterns comprise a first marking pattern and a second marking pattern, and the step of calculating the directional angle of the interactive controller according to the relative position relationship of the marking patterns in the marking image comprises:
calculating the directional angle of the interactive controller according to a first relative distance between a first position of the first marking pattern in the marking image and a second position of the second marking pattern in the marking image, wherein a pointing direction corresponding to the directional angle is a normal direction perpendicular to the surface presenting the marking patterns.

18. The control method of interactive display as claimed in claim 17, wherein the step of calculating the directional angle of the interactive controller according to the relative position relationship of the marking patterns in the marking image comprises:
comparing an actual distance with the first relative distance to calculate the directional angle, wherein the first marking pattern and the second marking pattern are spaced by the actual distance on the interactive controller.

19. The control method of interactive display as claimed in claim 17, further comprising:
producing an extending path along the directional angle based on the directional coordinate;
obtaining target coordinate of a target object on the extending path, and controlling the display to display content related to the target object according to the target coordinate.

20. The control method of interactive display as claimed in claim 12, wherein the marking image further comprises image content of another interactive controller, and the control method further comprises:
calculating other directional coordinate of the another interactive controller according to another directional angle and another location information of the another interactive controller; and
displaying another indication object at a position associated with the other directional coordinate on the display.
